(19) United States
(12) Patent Application Publication
(10) Pub. No.: US 2013/0221581 A1
(43) Pub. Date: Aug. 29, 2013

(54) PATTERN FORMATION APPARATUS, PATTERN FORMATION METHOD AND A METHOD FOR PRODUCING SEMICONDUCTOR DEVICES

(71) Applicant: Ikuo YONEDA, Kanagawa-ken (JP)

(72) Inventor: Ikuo YONEDA, Kanagawa-ken (JP)

(73) Assignee: KABUSHIKI KAISHA TOSHIBA, Tokyo (JP)

(21) Appl. No.: 13/607,396

(22) Filed: Sep. 7, 2012

(30) Foreign Application Priority Data
Feb. 24, 2012 (JP) 2012-039325

(51) Int. Cl. B29C 59/02; B29C 35/08

(52) U.S. Cl. 264/494; 425/155

(57) ABSTRACT

According to one embodiment, the pattern formation apparatus relating to the embodiment is a pattern formation apparatus wherein an object to be patterned (pattern transferring material) is irradiated with light under the state of affixing a three dimensional pattern formed on the main plane of a template to the object to transfer a reverse image of the three dimension pattern into the pattern transferring material the pattern transferring material. The pattern formation apparatus provides a light irradiation part and a control part. The light irradiation part is configured to irradiate light having intensity distribution in the irradiation plane parallel to the main plane. The control part is configured to control the light irradiation part to change the intensity distribution according to time.

### CROSS-REFERENCE TO RELATED APPLICATION

This application is based upon and claims the benefit of priority from Japanese Patent Application No. 2012-039325, filed Feb. 24, 2012; the entire contents of which are incorporated herein by reference.

### FIELD

Embodiments described herein relate generally to a pattern formation apparatus, a pattern formation method and a method for producing semiconductor devices.

### BACKGROUND

In the pattern formation methods, the imprint method, which uses a master plate (template) having an embossed pattern having protrusions and recesses that is transferred to an object has been used. In the imprint method, a photo-curable organic material, as an example, is coated on the substrate and cured by light irradiation in contact with the template of the organic material layer. This forms an embossed pattern by transferring a reverse image of the three-dimensional protrusions and recesses embossed pattern of the template onto the organic material layer.

It is important, in the pattern formation methods using a template, to form patterns in consideration of slippage of the embossed pattern of the template during embossing of a film with the pattern.

### DESCRIPTION OF THE DRAWINGS

FIG. 1 is a schematic diagram illustrating the pattern formation apparatus relating to the first embodiment.

FIG. 2 is a schematic diagram illustrating the constitution of the light irradiation part.

FIG. 3 A and FIG. 3B are schematic diagrams illustrating the region division of the irradiation plane.

FIG. 4 is a drawing illustrating the change of light intensity distribution with time.

FIG. 5A to FIG. 5C are schematic diagrams illustrating the change of the light intensity distribution in the irradiation region.

FIG. 6A and FIG. 6B are schematic plans illustrating the position slippage of the pattern in the irradiation region.

FIG. 7 is a diagram illustrating the relation between the light intensity and the stress during pattern curing.

FIG. 8 is a schematic diagram showing another constitution example of the light irradiation part.

FIG. 9 is a flowchart illustrating the pattern formation method relating to the second embodiment.

FIG. 10A to FIG. 10C are schematic cross-sectional views showing a concrete example of the pattern formation method.

### DETAILED DESCRIPTION

In general, one embodiment will be explained based on the drawings.

Furthermore, the drawings are schematic or conceptual, and the relation between thickness and width at each part and size ratio between parts are not necessarily equal to that in practice. Further, even in the case of showing the same place, sometimes the mutual dimension or ratio is expressed differently.

Furthermore, the same number is used for the same element as that in each drawing of the detailed description to avoid having to re-state a detailed explanation.

According to the embodiment, there is provided a pattern formation apparatus for carrying out pattern formation under consideration of position slippage due to unevenness pattern of the template, a pattern formation method and a method for producing semiconductor devices.

The pattern formation apparatus relating to the embodiment is a pattern formation apparatus wherein an object, such as a substrate having a pattern transferring thereon, is to be patterned according to an embossed pattern formed on a surface of a template. The object is irradiated with light under the state of affixing the embossed pattern of the template to the object to cure the pattern transferring, in order to transfer the embossed pattern to the object.

The pattern formation apparatus provides a light irradiation part and a control part.

The light irradiation part irradiates light having a variable intensity distribution in an irradiation plane that is substantially parallel to the plane of the surface of the template.

The control part controls the light irradiation part to change the intensity distribution according to time.

### Embodiment 1

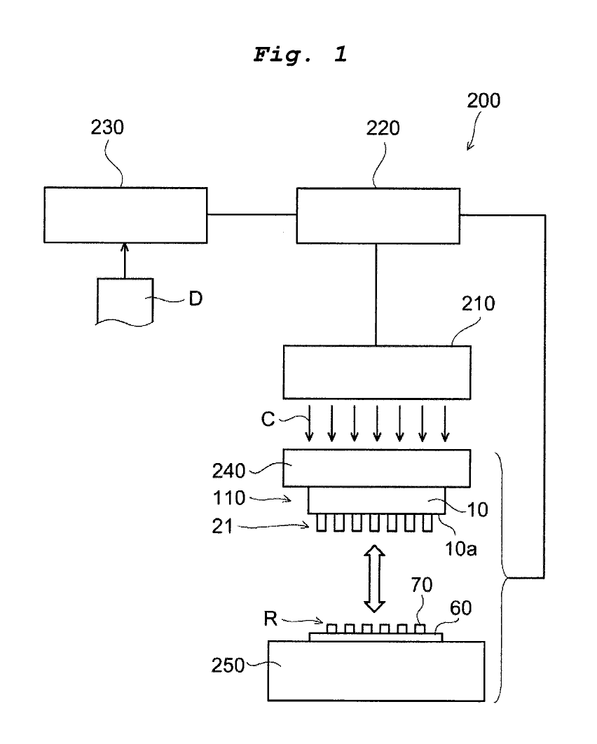

FIG. 1 is a schematic diagram illustrating the pattern formation apparatus relating to the first embodiment.

As expressed in FIG. 1, a pattern formation apparatus 200 relating to the first embodiment is an apparatus for forming a pattern on a pattern transferring material 70 using a template 110 on which a an embossed pattern 21 of protrusions and recesses is formed. Namely, the pattern formation apparatus 200 irradiates light C on the pattern transferring material 70 after affixing the pattern 21 of protrusions and recesses of the template 110 to the pattern transferring material 70 to cure the pattern transferring 70, in order to transfer the embossed pattern 21 to the pattern transferring 70.

Here, the template 110 has a base material 10 and the embossed pattern 21 is formed on a main plane 10a of the base material 10. The embossed pattern 21 of the template 110 is formed by using a master, or using photolithographic and etching techniques, for example. As the base material 10, for example, quartz is used. For the embossed protrusion and recess pattern 21, for example, a photo-curable organic material is used. In the case of forming a template 110 from the master, a photo-curable organic material is coated on the base material and the pattern of protrusions and recesses of the master is transferred to the photo-curable organic material as a negative three dimensional pattern of the template. The photo-curable organic material is cured to create therein the embossed pattern 21 as a negative, or inverse pattern, to the pattern of recesses and protrusions of the template 110 while to template is engaged with the photo-curable organic material.

The pattern formation apparatus 200 is provided with a light irradiation part 210 and a control part 220.

The light irradiation part 210 irradiates light C having an intensity distribution within an irradiation plane R that is substantially parallel to the main plane 10a of the base material 10 of the template 110. Here, the irradiation plane R is a plane in parallel to the main plane 10a in the region of the pattern transferring material 70 being irradiated with the light C. Further, an intensity of light indicates an energy density of light. The light irradiation part 210 provides a mechanism capable of changing the intensity distribution of light C in the irradiation plane R.

The control part 220 controls the light irradiation part 210 to change the intensity distribution of light C within the irradiation plane R according to time.

In the pattern formation apparatus 200 relating to this embodiment, the intensity distribution of light C in the irradiation plane R is changed with time to control distortion caused during curing of the pattern transferring material 70 by light C. Namely, the intensity distribution of light C in the irradiation plane R is changed by time so that the balance of shrinkage distortion caused during curing by light C of the pattern transferring material 70 in the irradiation plane R is controlled. This adjusts the position of the pattern being formed by curing the pattern transferring material 70 in the irradiation plane R. Thus, even when there is a position slippage with respect to a standard (a foundation pattern, an alignment mark or other position indicator) in the embossed pattern 21 of the template 110, the influence of the slippage on the pattern being formed on the pattern transferring material 70 is prevented.

An input part 230 may be installed in the pattern formation apparatus 200. The input part 230 is a part for inputting data D showing the change of the intensity distribution of light C in the irradiation plane R with time. The input part 230 includes an input interface of the nonvolatile memory and interface with a network, for example, various input devices such as a keyboard, pointing device, etc. Namely, the data D are input by the input device from a nonvolatile memory or external devices (computer, database, etc.) through the network.

Here, the data D include the relation between the slippage amount and direction with respect to the standard of embossed pattern 21 of the template 110, as well as the change of intensity distribution of light C in the irradiation plane R with time. The standard of the embossed pattern 21 includes the design value of the embossed pattern 21, position of the pattern transferred to the pattern transferring material relative to the foundation pattern, the position of an element, such as an alignment mark, formed on a substrate, etc.

The pattern formation apparatus 200 provides a retaining part 240 for retaining the template 110 and a stage 250 for holding the substrate 60. The retaining part 240 is adsorption-retained, for example, at the side opposite to the embossed pattern 21 of the base material 10 of the template 110.

The stage 250 is fixed at the position at which the substrate 60 is located. The pattern transferring material 70 is placed on the substrate 60.

The control part 220 controls the distance between the retaining part 240 and the stage 250. Namely, a moving mechanism (not shown) is provided at the retaining part 240 and/or the stage 250 to move the retaining part 240 and/or the stage 250 toward the other. The control part 220 controls the moving mechanism to control the distance between the retaining part 240 and the stage 250. In this way, contact of the embossed pattern 21 of the template 110 to the pattern transferring material 70 and releasing of the template 110 from the pattern transferring material 70 are carried out.

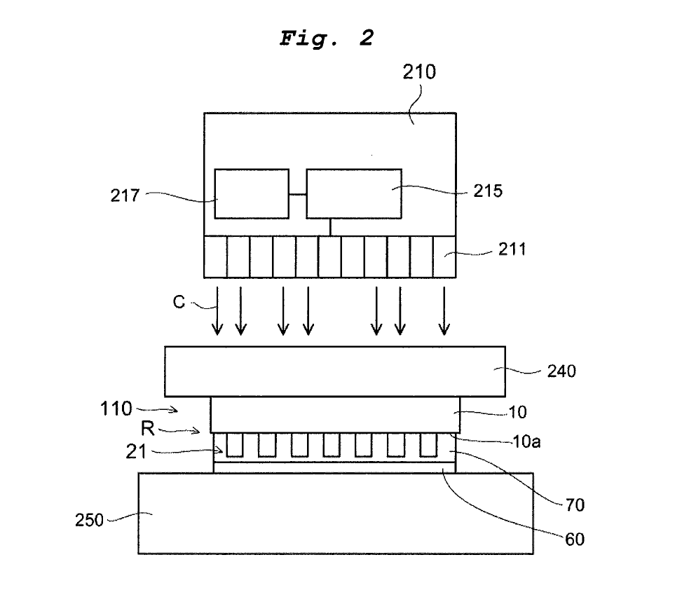

FIG. 2 is a schematic diagram illustrating the constitution of the light irradiation part.

The light irradiation part 210, retaining part 24 and stage 250 in the constitution of the pattern formation apparatus 200 are shown in FIG. 2.

The light irradiation part 210 includes a dividing part 211 and a regulation part 215. The dividing part 211 may be a beam splitter that divides the irradiation of light C into plural regions in the irradiation plane R in parallel to the main plane 10a. In the dividing part 211, plural optical fibers, as an example, are used. In this case, the dividing part 211 branches the light released from the light source 217 by plural optical fibers to irradiate it onto plural regions in the irradiation plane R. As the light source 217, for instance, a high-pressure mercury lamp is used. The light to be released from the light source 217 consists of ultraviolet rays of, for instance, about 310 nanometers (nm).

Plural reflex mirrors may be used in the dividing part 211. In this case, the light released from the light source 217 is irradiated onto plural regions in the irradiation plane R, respectively, by the plural reflex mirrors.

The regulation part 215 regulates the intensity of light C in plural regions divided by the dividing part 211 according to the intensity distribution. In the regulation part 215, liquid crystal element, as an example, is used. When optical fibers are used as the dividing part 211, liquid crystal elements are installed in plural optical fibers, respectively. The regulation part 215 regulates the light transmittance of each liquid crystal element. In this way, the intensity of light C irradiated to plural regions respectively from each optical fiber in the irradiation region R is regulated. The regulation part 215 regulates the intensity of light C in plural regions in the irradiation plane R according to the intensity distribution in accordance with the instruction from the control part 220.

The function of the dividing part 211 and the regulation part 215 may be different from each other. As the dividing part 211, for example, independent plural light sources 217 may be used for each of the plural regions. In this case, the regulation part 215 regulates the intensity of radiation of independent plural light source 217 to regulate the intensity of light C being irradiated to each of plural regions in the irradiation plane R.

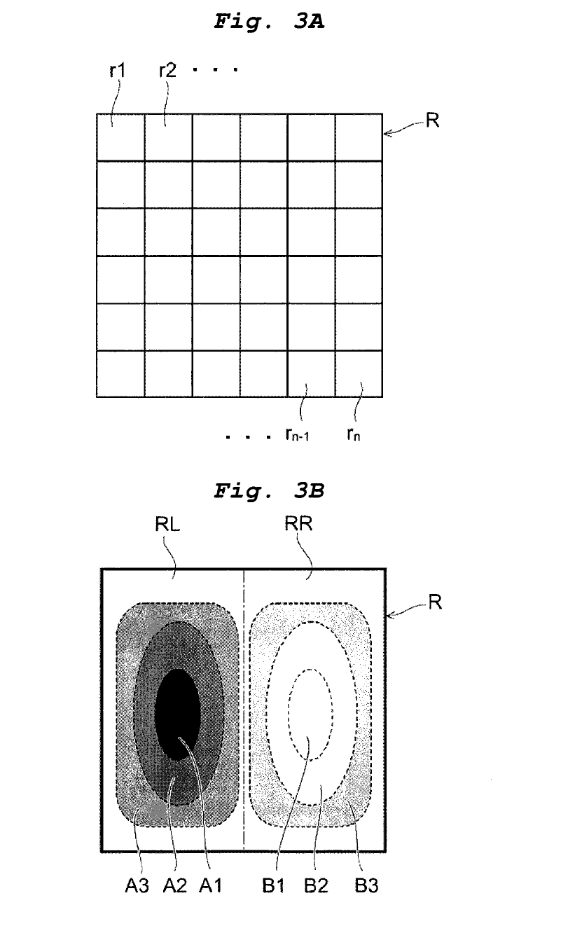

FIG. 3A and FIG. 3B are schematic diagrams illustrating the region division of the irradiation plane. FIG. 3A is a schematic plan illustrating the irradiation plane R, and FIG. 3B is a schematic plan illustrating the intensity distribution of light C in the irradiation plane R.

As shown in FIG. 3A, light C being irradiated on the irradiation plane R is divided into plural regions r1, r2, . . . rn-1, and rn by the dividing part 211. In the example shown in FIG. 3A, the in-plane of the irradiation plane R consists of plural regions in the length and width directions, but it may be divided in the length or width directions.

The regulation part 215 shown in FIG. 2 regulates the irradiation intensity of light C on each of the plural regions r1, r2, . . . rn-1, and rn shown in FIG. 3A.

In this way, when the intensity of light C on plural regions r1, r2, . . . rn-1, and rn in the irradiation plane R is regulated by the light irradiation part 210, the intensity distribution of light C in the irradiation plane R can be set up as shown in FIG. 3B as an example. It is shown in FIG. 3B that the darker the area, the higher the intensity of light C is irradiated in the area.

When the irradiation plane R is divided into, for example, the region RL (left side) and the region RR (right side) in the example of intensity distribution as shown in FIG. 3B, the intensity of light C of the region A1, which is the part of region RL, becomes higher, while the intensity of light C of the region B1, which is the part of the region RR of the right side, becomes lower. Furthermore, the intensity of light C becomes lower toward the region A2, with region A3 surrounding the region A1 as the center being the highest in intensity, and the intensity of light C becomes higher toward the region B2, with region B3 surrounding the region B1 as the center being the lowest intensity.

The light irradiation part 210 regulates the intensity of light C in the irradiation plane R in plural regions r1, r2, . . . rn-1, and rn to give the intensity distribution as shown in, for example, FIG. 3B. Further, the light irradiation part 210 changes the intensity distribution with time according to the instruction from the control part 220.

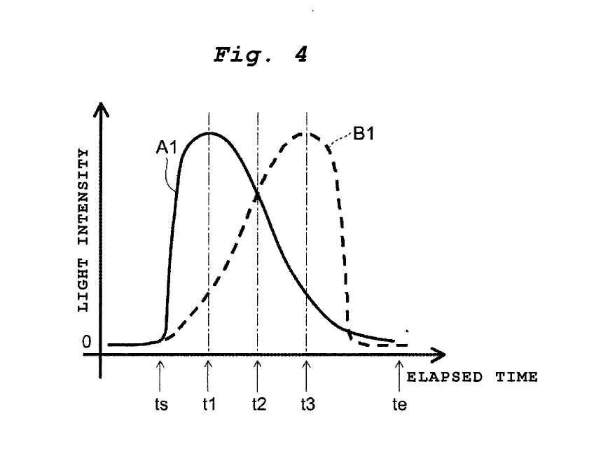

FIG. 4 is a diagram illustrating the change of intensity distribution of light with time.

In FIG. 4, the abscissa shows time and the ordinate shows the light intensity. The change of light intensity in the region A1 and the region B1, which is shown in FIG. 3B, is shown in FIG. 4.

In the example shown in FIG. 4, the light intensity of the region A1 rapidly increases during the period from the irradiation initiation time is of light C to time t1, and slowly weakens during the period from time t1 to time t2, t3. On the other hand, the light intensity of the region B1 slowly increases during the period from irradiation initiation time ts of light C to time t1, t2, t3 and rapidly decreases during the period from time t3 to irradiation end time te.

In FIG. 4, the change of light intensity in the region A1 and region B1 is shown, but the light intensity is changed with time in other regions that are different from the irradiation plane R.

If the intensity distribution of light C is changed with time, the amount of shrinkage that occurs during curing of the pattern transferring material 70 is changed. Shrinkage induces stress in the pattern transferring material that is being cured. If the light intensity of the region A1, for example, is increased in a short time from the initiation time ts of irradiation, the pattern transferring material 70 is rapidly cured from a soft state. Therefore, the shrinkage amount that occurs with curing of the pattern transferring material 70 increases. On the other hand, like the light intensity of the region B1, the light intensity is slowly increased from the initiation time ts of irradiation, and the pattern transferring material 70 is slowly cured from a soft state. Therefore, the shrinkage amount that occurs with curing of the pattern transferring material 70 decreases.

The shrinkage amount of the pattern transferring material 70 in the irradiation plane R is regulated by giving the intensity distribution of light C in the irradiation plane R and changing the intensity distribution with time. In this way, regulation of the position after curing the pattern that is being transferred to the pattern transferring material 70 is carried out.

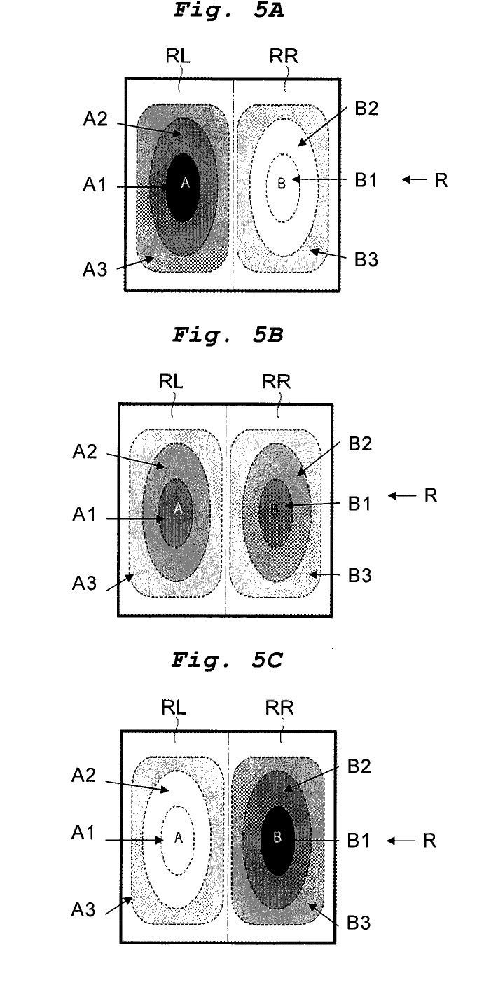

FIG. 5A to FIG. 5C are schematic diagrams illustrating the change of intensity distribution on the irradiation plane. The intensity distribution at time t1 shown in FIG. 4 is shown in FIG. 5A, the intensity distribution at time t2 shown in FIG. 4 is shown in FIG. 5B, and the intensity distribution at time t3 shown in FIG. 4 is shown in FIG. 5C.

At time t1, the intensity of light of region A1 in the left-side region RL of the irradiation plane R is high, and the intensity of light in the regions A2 and A3 surrounding region A1 becomes lower as shown in FIG. 5A. In the region RR at the right side of the irradiation plane R, the intensity of light in the region B1 is low, and the intensity of light in its surrounding regions B2 and B3 is higher.

FIG. 5B shows the intensity of light from time t1 to t2, the intensity of light of the region A1 and the region A2 in the left side region RL of the irradiation plane R is lower, and the intensity of light of the region B1 and the region B2 in the region RP at the right side of the irradiation plane R is higher. In this way, the intensity distribution of light in the region RL at the left side of the irradiation plane R becomes almost equal to the intensity distribution of light in the region RR at the right side of the irradiation plane R.

Further, as shown in FIG. 5C, when light intensity is changed from time t2 to t3, the intensity of light of the region A1 in the region RL at the left side of the irradiation plane R is lower, and the intensity of light becomes high in the regions A2 and A3. In the region RR at the right side of the irradiation plane, the intensity of light in the region B1 is high, and the intensity of light C is lower in the surrounding regions B2 and B3.

Namely, as shown in FIG. 5A to FIG. 5C, the intensity distribution of light in the region RL at the left side of the irradiation plane R over the time t1, t2 and t3 is substantially reversed with that in the region RR at the right side. By this change of intensity distribution with time, the total irradiation amount of light in the irradiation plane R becomes almost equal. Namely, even when the intensity of light is changed with time in each region A1, A2, A3, B1, B2 and B3, the total irradiation amount of light in the irradiation plane R becomes uniform. When a pattern is transferred to the pattern transferring material 70, the irradiation amount of light is influenced by the dimensions of the pattern. Therefore, if the total irradiation amount of light in the irradiation plane R is substantially uniform, the dimension of pattern transferred to the pattern transferring material 70 after curing is substantially the same as the design value (i.e., the negative of the three-dimensional image embossed pattern 21 of the base material 10 of the template 110).

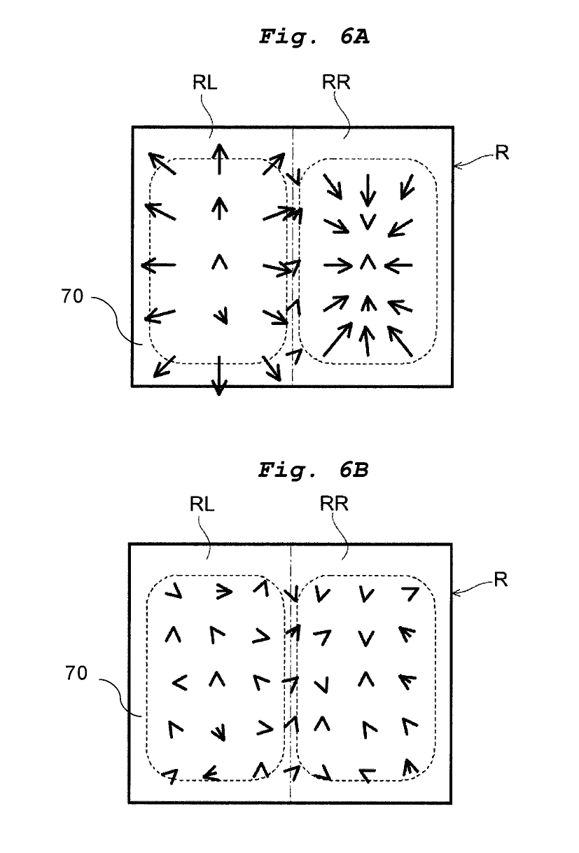

FIG. 6A and FIG. 6B is a schematic diagram illustrating slippage in a transferred pattern formed in the pattern transferring material 70, such as a photo-curable organic material on a substrate, in the irradiation region R.

FIG. 6A shows the slippage when a pattern is formed by irradiating light at uniform intensity, and FIG. 6B shows the slippage when a pattern is formed by irradiating light at varied intensity. In both diagrams, the length of the arrow shows the magnitude of slippage of pattern, and the direction of the arrow shows the slippage direction. The slippage of the transferred pattern is a slippage based on the foundation pattern as an example.

When the irradiation plane R is irradiated with light at uniform intensity and the pattern transferring material 70 is cured as shown in FIG. 6A, the slippage of the pattern transferring material 70 cannot be sufficiently corrected. When there is a slippage, i.e., undesired positional change, in the pattern formed in the pattern transferring material 70, and after the reduction (shrinkage) of the pattern transferring material 70 or modification of orthogonality (cross-linking) is carried out, the imprinted pattern in the pattern transferring material 70 cannot be corrected. Various attempts to correct slippage, for example, by rotating while retaining the template 110 at the retaining part 240 and/or applying pressure on the end part of the base material 10 have been utilized but are not sufficient. Additionally, when there is a slippage in the pattern transferring material 70, the stresses may cause shrinkage in the pattern transferring material 70, which promotes undesirable adherence of portions of the pattern in the cured pattern transferring material 70 to the embossed pattern 21 of the template 110. The adherence may cause difficulty in removing the template 110 from the pattern transferring material 70, or may create other defects such as pulling away of a portion of the pattern in the pattern transferring material when the template is removed therefrom. Adhered portions of the pattern transferring material 70 may be removed with the embossed pattern 21 of the template 110, which causes pullout defects in the cured pattern transferring material 70.

In the example shown in FIG. 6A, slippage of pattern occurs from the center to periphery in the left side region RL of the irradiation plane R. Further, slippage of pattern occurs from periphery to the center in the right side region RR of the irradiation plane R.

When intensity distribution of light is provided to the irradiation plane R and the intensity distribution is changed with time as shown in FIG. 6B, the slippage of the pattern transferring material 70 is sufficiently modified. In one aspect, only small regions of the pattern transferring material 70 are modified to correct slippage as opposed to modification of the entire pattern being formed in the pattern transferring material 70.

In the example shown in FIG. 6B, the intensity distribution of light in the irradiation plane R is changed according to time as shown in FIG. 5A to FIG. 5C to form a pattern on the pattern transferring material 70. When the intensity distribution of light is changed as described above, the pattern position moves from the periphery to the center in the left side region RL of the irradiation plane R, and the pattern position moves from the center to the periphery in the right side region RR of the irradiation plane R. Therefore, the slippage of the pattern can be sufficiently modified as shown in FIG. 6B by moving the formation position of pattern to the direction of offsetting the slippage of pattern shown in FIG. 6A. Namely, the slippage, which could not be modified by other means, is modified.

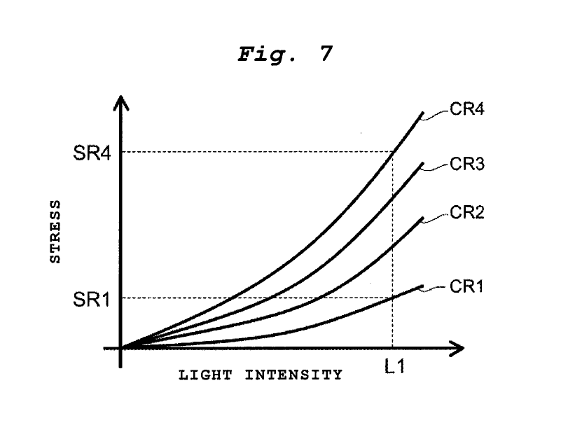

FIG. 7 is a diagram illustrating the relation between the light intensity and stress in curing of a pattern.

In FIG. 7, the abscissa indicates intensity of light C being irradiated to the pattern transferring, and the ordinate indicates stress in curing of a pattern. Further, in FIG. 7, the relation between intensity of light C and stress in curing of pattern is shown using variation (increment of intensity per unit time) of intensity of light C as a parameter. Here, the variation of intensity of light C becomes higher in order from CR1 to CR4.

The higher the variation of intensity of light C the greater the stress in the curing pattern as shown in FIG. 7. The pattern formation apparatus 200 relating to the present embodiment regulates the intensity distribution of light C in the irradiation plane R by utilizing the relation shown in FIG. 7.

When adjoining two regions (first region r1 and second region r2 (FIG. 2)) among plural regions resulted by dividing the irradiation plane R are irradiated with a prescribed light intensity L1, the changing ratio of intensity of light C being irradiating to the first region r1 is set to first changing ratio CR1, and the changing ratio of intensity of light C being irradiating to the second region r2 is set to fourth changing ration CR4. In the charging ratio CR1 and the changing ratio 4 in light intensity L1, the stress in curing of pattern becomes SR1 and SR4, respectively, from the relation shown in FIG. 7. The pattern of the first region r1 moves to the direction of the second region r2, which has higher stress, by the amount corresponding to the difference in the magnitude of stress (SR4-SR1).

In the pattern formation apparatus 200 relating to this embodiment, irradiation of light C to the pattern transferring material 70 is controlled based on the data D showing the relation between the pattern feature slippage amount and direction of the embossed pattern 21 of the template 110 from the standard (for example, a foundation pattern), and change of intensity distribution of light C irradiating in the irradiation plane R with respect to time.

The data D may be determined by calculation in the control part 220 or may be inputted from outside by the input part 230.

Even when there is pattern feature slippage of the embossed protrusions and recesses of the negative of the three dimensional pattern of template 110, the slippage is modified when transferring to the pattern transferring material 70 and curing by the pattern formation apparatus 200 relating to this embodiment. Thus, a pattern is formed at a precise position with respect to the standard (for example, foundation pattern) by imprinting using template 110.

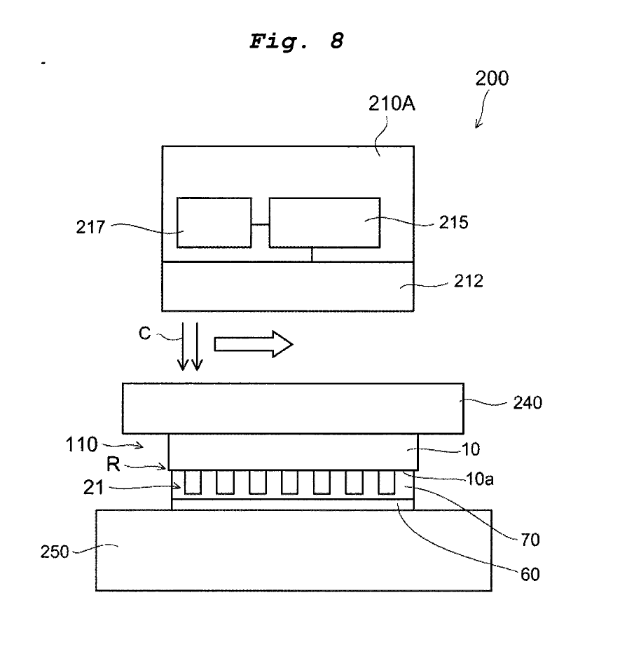

FIG. 8 is a schematic diagram showing another example of a light irradiation part 210A.

In FIG. 8, light irradiation part 210A, retaining part 24 and stage 250 are shown, among the other parts of the pattern formation apparatus 200.

The light irradiation part 210A includes a scanning part 212 and the regulation part 215.

The scanning part 212 is a part wherein the irradiation position of light C is moved successively in the irradiation plane R in parallel to the main plane 10a of the base material 10 of template 110. In the scanning part 212, for instance, a movable mirror is installed to change the progress direction of light C released from the light source 217.

The regulation part 215 regulates the intensity of light C scanned from the scanning part 212 by the instruction of the control part 220. The regulation part 215 regulates the intensity of light C released from the light source 217 by directly controlling the light source 217. The regulation part 215 may regulate the quantity of light released from the light source 217 through a light-sensing device such as liquid crystal element, etc. The regulation part 215 regulates the intensity of light C in conjunction with the irradiation position of light C scanned by the scanning part 212. In this way, a prescribed intensity distribution is obtained in the irradiation plane R.

The scanning part 212 repeats scanning of light C in the irradiation plane R. The regulation part 215 conducts the regulation of light quantity so as to obtain one intensity distribution by scanning at least once light C in the irradiation plane R. The regulation part 215 regulates the quantity of light so as to change the intensity distribution together with repeating of scanning of light C in the irradiation plane R by the scanning part 212. The change of intensity distribution with time is carried out by scanning of light C multiple times to the irradiation plane R.

Even when the intensity distribution is obtained by scanning light C as above, the intensity of light C is regulated so as to make total irradiation quantity of the light C (accumulated irradiation quantity by plural scanning) in the irradiation plane R uniform.

In the scanning of light C by the scanning part 212, regulation of light quantity in rather minute regions on the irradiation plane R or continuous regulation of light quantity in the scanning direction is carried out.

### Embodiment 2

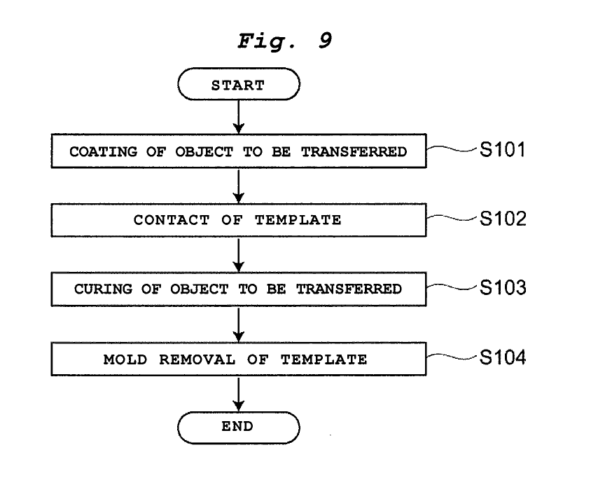

FIG. 9 is a flowchart illustrating the pattern formation method relating to the second embodiment.

The pattern formation method relating to this embodiment is an imprinting method of transferring the reverse image of the protrusions and recesses forming the three dimensional embossed pattern of the template to the pattern transferring material 70 using template 110 having an embossed pattern 21.

The template 110 to be used in the pattern formation method relating to this embodiment provides a base material 10 having main plane 10a and the embossed pattern 21 formed on the main plane 10a of the base material 10.

FIG. 9 shows the pattern formation method using the template 110.

First, a pattern transferring material 70 is coated on the substrate 60 as shown in step S101. The pattern transferring material 70 is a photosensitive material. A photo-curable organic substance is used as the photosensitive material.

Next, the template 110 is positioned to be in contact with the pattern transferring material 70 as shown in step S102. In this way, the pattern transferring material 70 flows into depressions as part of the embossed pattern of the template 110.

Next, the pattern transferring material 70 is cured after contacting of the template 110 to the pattern transferring material 70 as shown in step S103. Since a photo-curable organic substance is used as the pattern transferring material 70 in this embodiment, the pattern transferring material 70 is curable by irradiating with light (for instance, ultraviolet ray) C.

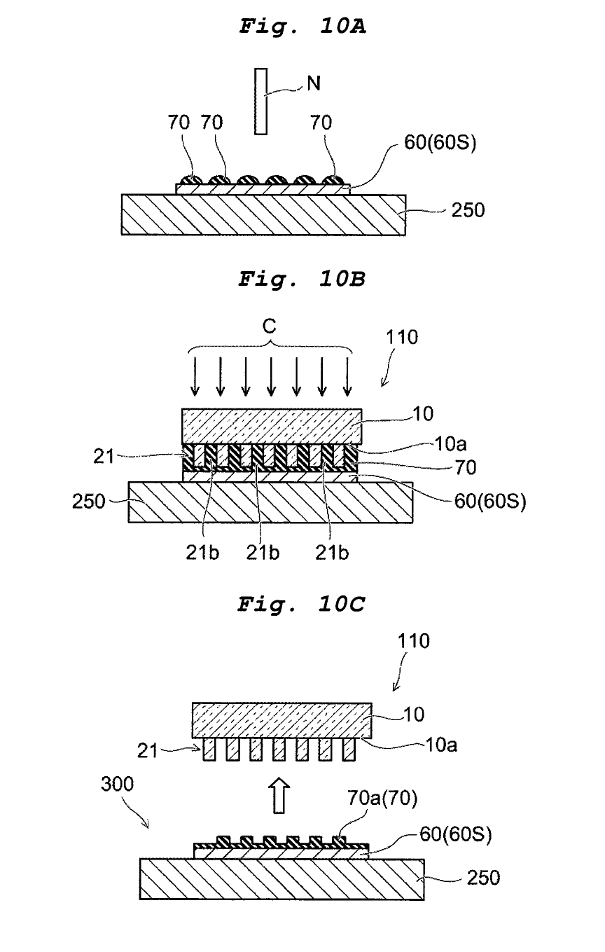

After curing the pattern transferring material 70, the template 110 is removed as shown in step S104. In this way, the embossed pattern 21 of the template 110 is transferred to the pattern transferring material 70. A reversed embossed transfer pattern 70a, i.e., a negative image of the three dimensional features of the pattern 21 of protrusions and recesses on the template 110, (FIG. 10C) is formed on the pattern transferring material 70 from the embossed pattern 21 of the template 110 into the pattern transferring material 70.

In the pattern formation method relating to this embodiment, the intensity distribution of light C in the irradiation plane R in parallel to the main plain 10a is changed with time in the step of curing the pattern transferring material 70 as shown in step S103.

FIG. 10A to FIG. 10C are schematic cross-sectional views showing concrete example of the pattern formation method.

In FIG. 10A to FIG. 10C, an example for producing semiconductor device 300 by the pattern formation method relating to this embodiment is shown.

First, a pattern transferring material 70 is formed on the substrate 60 as shown in FIG. 10A. In the method for producing semiconductor device 300, for example, a semiconductor layer 60S is included in the substrate 60. An element such as transistor, etc. may be formed in the semiconductor layer 60S.

As the pattern transferring material 70, a photo-curable organic substance, as an example, is used. The pattern transferring material 70 is dropped on the substrate 60, for instance, from nozzle N by ink jet method. Furthermore, the pattern transferring material 70 may be formed uniformly by spin coat, etc.

Then, a template 110 as shown in FIG. 10B is prepared The template 110 to be used in the pattern formation method relating to this embodiment provides an embossed three dimensional pattern 21 of protrusions and recesses which are formed on the main plane 10a of the base material 10.

Next, the embossed pattern 21 of the template 110 makes contact with the pattern transferring material 70. The pattern transferring material 70 flows into a plurality of depressions 21b of the embossed pattern 21 by capillary phenomenon to fill in the depressions 21b.

Next, light C is irradiated from the base material 10 side of template 110 to the pattern transferring material 70 in contact with the embossed pattern of the template 110. The light C is, for example, ultraviolet ray. The light C penetrates the base material 10 and the concave-convex pattern 21 and irradiates to the pattern transferring material 70. The pattern transferring material 70 from a photo-curable organic substance is cured by irradiating with light C.

In the irradiation of light C, as explained previously, the intensity distribution of light C in the irradiation plane R in parallel to the main plane 10a is changed with time. This regulates the stress by shrinkage in curing the pattern transferring material 70.

Next, the template 110 is removed from the pattern transferring material 70 as shown in FIG. 10C. In this way, the reverse image of the three dimensional features of the embossed pattern 21 of the template 110 is transferred to the pattern transferring material 70 to form a transfer pattern 70a.

In contacting the template 110 to the pattern transferring material 70, sometimes it is desirable that a plurality of protrusions 21a of the embossed pattern 21 do not contact the surface of the substrate 60. In this case, a portion of the pattern transferring material 70 remains interposed between the surface of the substrate 60 and the protrusion and recess pattern 21a and the template 110 is then removed. The pattern transferring material 70 remains at the bottom of the depressions in the pattern of the transfer pattern 70a.

Further, when the substrate 60 is processed by using the transfer pattern 70a as mask, the substrate 60 is etched by, for instance, anisotropic RIE (Reactive Ion Etching). During etching, the thin portion of the pattern transfer material 70 at the base of the recesses of the material is etched away, while the portions of the pattern transfer material extending from the substrate 60 are etched as well, but because they are thicker they continue to mask the underlying portions of the wafer from the etch chemistry. As a result, a pattern is etched into the substrate having the same three dimensional pattern as the protrusions and recesses of the pattern transferring material. After etching, the transfer pattern 70a is removed. In this way, a pattern corresponding to the transfer pattern 70a is formed on the substrate 60. A pattern is formed on the substrate 60 including the semiconductor layer 60S to complete the semiconductor device 300.

In the imprinting method, each process shown in FIG. 10A to FIG. 10C is repeated on the same or different substrate using additional pattern transferring material 70 with the same template 110. In this way, the same pattern may be repeatedly formed using one template 110. Therefore the productivity of fabrication of semiconductor devices 300 is improved.

In the production method of semiconductor device 300 by applying the pattern formation method as above, patterns, the feature or pattern slippage of which are modified based on the standards (for instance, position of an element formed on the semiconductor layer 60S or foundation pattern) of the embossed pattern 21 of the template 110, such as transfer pattern 70a, etc. result. When a pattern such as transfer pattern 70a, etc. is formed on the foundation pattern, the position setting with respect to the foundation pattern is carried out precisely. By methods described herein, the semiconductor device 300 having high positional accuracy of a plurality of transfer patterns is provided.

As explained above, according to pattern formation apparatus relating to this embodiment, pattern formation method, and production method of semiconductor device, pattern formation under consideration of position slippage of embossed pattern of a template can be carried out.

Although the embodiment of the present invention was explained above, the present invention is not limited to this only. For instance, the intensity distribution of light C explained above is an example, and it is suitably established according to the amount of slippage and direction of slippage with respect to the standard of the embossed pattern 21. Furthermore, those obtained by suitably adding, and deleting constitutional elements, and modifying the design thereof with respect to the each embodiment by professions of this field, and those obtained by combining suitably the characteristic of each embodiment are included in the scope of the present invention as long as it provides the gist of the present invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pattern formation apparatus in which a pattern transferring material disposed on an object is embossed with a three dimensional pattern by a template having an embossed pattern formed on a main plane of the template, and the pattern transferring material is irradiated with light to cure the pattern transferring material and transfer the reverse image of the embossed pattern to the object, pattern transferring the pattern forming apparatus comprising:
a light irradiation part configured to irradiate light having an intensity distribution in an irradiation plane parallel to the main plane; and
a control part configured to control the light irradiation part and change the intensity distribution according to time.

2. The pattern formation apparatus according to claim 1, further comprising:
an input part configured to provide data showing a change of the intensity distribution with time, wherein the control part controls the light irradiation part by the data provided by the input part.

3. The pattern formation apparatus according to claim 2, wherein the data corresponds to a relation between feature slippage amount and a direction of the embossed pattern from a standard and a change of the intensity distribution with time.

4. The pattern formation apparatus as according to claim 1, wherein the control part changes the intensity distribution of light to provide a uniform total irradiation quantity in the irradiation plane within a fixed time.

5. The pattern formation apparatus according to claim 1, wherein the light irradiation part comprises:
a beam splitter configured to divide the light into plural regions in the irradiation plane; and
a regulation part configured to regulate the intensity of the light according to the intensity distribution in each of the plural regions.

6. The pattern formation apparatus according to claim 1, wherein the light irradiation part comprises:
a scanning part configured to move successively an irradiation position of the light in the irradiation plane; and
a regulation part configured to regulate the light intensity according to the irradiation position moving by the scanning part and the intensity distribution.

7. A pattern formation apparatus in which a pattern transferring material disposed on an object is patterned by positioning a template having an embossed pattern formed on a main plane of the template in a position to receive the pattern transferring material into recesses formed therein, and the pattern transferring material is irradiated with light to cure the pattern transferring material resulting in a negative image of the pattern of features having recesses and protrusions being formed within the pattern transferring material,
the pattern forming apparatus comprising:
a light irradiation part configured to irradiate light having an intensity distribution in an irradiation plane parallel to the main plane, and having a dividing portion configured to divide the light into plural regions in the irradiation plane, and a regulation part configured to regulate an intensity of the light according to the intensity distribution in each of plural regions;
an input part configured to input data relating to the relation between an amount and direction of deviation of the pattern feature from a standard, and a change of the light intensity distribution with time; and
a control part configured to control the light irradiation part by data inputted by the input part, and change the intensity distribution according to time so as to make uniform the total irradiation amount of light in the irradiation plane within a fixed time.

8. The pattern formation apparatus of claim 7, wherein said template is configured to remain in contact with said pattern transferring material during light irradiation of the pattern transferring material.

9. The pattern formation apparatus of claim 7, further including a retainer configured to hold said template, and a stage on which said object is received; and
a positioner configured to position said template on said retainer relative to said object on said stage such that said template is positionable while in contact with the pattern transferring material located on said object yet spaced from said object.

10. The pattern formation apparatus of claim 9, wherein said retainer is positionable to position the three dimensional features into contact with said pattern transferring material such that said pattern transferring material may flow, by capillary action, into the recesses of the three dimensional features of said template.

11. A pattern formation method, comprising:
affixing an embossed three dimensional pattern of protrusions and recesses formed on a main plane of a base material of a template to a pattern transferring material disposed on an object where the negative three dimensional image of the embossed pattern is to be transferred;
irradiating the object with light through the embossed three dimensional pattern to cure the pattern transferring material while maintaining contact between the template and the pattern transferring material; and
removing the template from the pattern transferring material, wherein curing the pattern transferring material includes:
irradiation of light having an intensity distribution in an irradiation plane, parallel to the main plane, on the pattern transferring material; and
changing an intensity distribution of light with time.

12. The pattern formation method according to claim 11, wherein curing the pattern transferring material includes:
inputting of data showing a change of the intensity distribution with time; and
controlling of the intensity of light being irradiated to the pattern transferring material by the data.

13. The pattern formation method according to claim 12, wherein the data corresponds to a relation between a slippage amount and a direction of the embossed pattern from a standard, and change of the intensity distribution with time.

14. The pattern formation method according to claim 11, wherein curing the pattern transferring comprises changing the intensity distribution of light at different locations of the pattern transferring material to provide a uniform overall total irradiation quantity in the irradiation plane within a fixed time.

15. The pattern formation method according to claim 11, wherein curing the pattern transferring material comprises dividing the light into plural regions in the irradiation plane and regulating the light intensity in each of the plural regions according to the intensity distribution.

16. A method for producing semiconductor devices, comprising:
forming a pattern by a pattern formation method comprising:
affixing an embossed three dimensional pattern of protrusions and recesses formed on a main plane of a base material of a template to a pattern transferring material disposed on an object into which a reverse image of the embossed pattern is to be transferred;
irradiating the object with light through the embossed pattern to cure the pattern transferring material; and
removing the template from the pattern transferring material, wherein curing the pattern transferring material includes:
irradiation of light having an intensity distribution in an irradiation plane, parallel to the main plane, on the pattern transferring material; and
changing an intensity distribution of light with time.

17. The method according to claim 16, wherein curing the pattern transferring material includes:
inputting of data showing a change of the intensity distribution with time; and
controlling of the intensity of light being irradiated to the pattern transferring material by the data.

18. The method according to claim 17, wherein the data corresponds to a relation between a slippage amount of a feature of the pattern being created in the pattern transferring material and a direction of the embossed pattern from a standard, and change of the intensity distribution with time.

19. The method according to claim 17, wherein curing the pattern transferring material comprises changing the intensity distribution of light to provide a uniform total irradiation quantity in the irradiation plane within a fixed time.

20. The method according to claim 17, wherein curing the pattern transferring material comprises dividing the light into plural regions in the irradiation plane and regulating the light intensity in each of the plural regions according to the intensity distribution.
